(19) United States
(12) Patent Application Publication
(10) Pub. No.: US 2012/0116992 A1
(43) Pub. Date: May 10, 2012

(54) System and Method for Analyzing Investments

(76) Inventor: Mitchell Jay Tuchman, Menlo Park, CA (US)

(21) Appl. No.: 12/941,979

(22) Filed: Nov. 8, 2010

(51) Int. Cl. G06Q 40/00

(52) U.S. Cl. 705/36 R

(57) ABSTRACT

An online investment advisory and management tool providing a system, method and apparatus for analyzing the actual cost of ownership, over time, of mutual funds and comparing those costs to the costs associated with a determined comparable exchange traded fund(s) (ETFs). The method includes an analysis of investment costs and the implicit asset allocation of the funds entered. According to one method, a user inputs mutual fund information into a client and the data is sent to a server. In an alternative embodiment, the user entitles the client to determine actual account information from a third party communicating with the user's financial institution(s). The server analyzes the mutual funds, and determines comparable ETFs. Alternatively, the user may select ETFs. After an ETF is determined, the system provides an analysis of the costs and performance of the mutual funds and the comparable ETFs and estimates the total cost of ownership. The embodiments further include a marketing tool.

### FIELD

The present invention relates generally to providing investment management fee estimates, over a network and, more particularly, but not exclusively to providing an analysis of the cost of owning particular investment vehicles, identifying comparable investments with lower management fees and comparing such costs over time.

### BACKGROUND

With the advent of the Internet and online brokerage options, investors have more and more options when choosing investments today and often act independently without consulting a professional in the investment industry. Further, information regarding investments is more readily available, however information concerning the actual cost of owning one investment versus another is still scarce and may be difficult to obtain. As a result, for example, in order to reduce risk, investors often chose to invest in mutual funds as opposed to individual stocks.

In general, the fees for an actively managed mutual fund tend to be in the range of six to ten times greater then the fees of a passively managed index or exchange traded fund (ETF). Proponents of actively managed mutual funds contend that the fees are justified through superior investment performance. However investors are typically unable to handle or determine whether such claims are true, the amounts of the fees that are being charged, the degree to which the mutual fund advertises one strategy and then implements one that is different in order to achieve superior performance (“Style Drift”) the degree of actual performance needed to match the performance of a comparable ETF. Therefore, there is a need for a mechanism, that provides the true cost of ownership of mutual funds as compared to the true cost of ownership of comparable ETFs. Embodiments of the present invention provide a novel and non-obvious fund comparator that allows an investor to understand the effects of fees on the performance of a specific mutual fund investment, identifying comparable ETFs and comparing the performance of the mutual fund investment to the performance of a comparable ETF after fees are taken into consideration. Embodiments further provide a novel time-based analyzer system, which shows the investor how the mutual fund must perform in order to overcome the drag on the portfolio due to fees over time.

### BRIEF SUMMARY

In accordance with a preferred embodiment of the present invention, a system for generating an investment fee analysis report is provided, the system includes a host module, adapted to receive investment information about at least one investment of interest to an investor and including a data input link for receiving information about the at least one investment of interest; a first logic processing module programmed to determine at least one alternative investment that is comparable to the at least one investment of interest, wherein the logic processing module uses predefined criteria to identify the at least one alternative investment; a database module, adapted to obtain data concerning the at least one alternative investment and the at least one investment of interest; a fee module, adapted to determine ownership fees associated with the at least one investment of interest and the at least one alternative investment; and a reporting module, adapted to prepare and send investment fee reports.

In addition, a computer readable medium encoded with a computer program for generating an investment fee analysis report is provided. The computer program includes instructions for: identifying at least one investment of interest; receiving information about the at least one investment of interest; determining at least one alternative investment that is comparable to the at least one investment of interest; receiving information about the at least one alternative investment; determining ownership fees associated with the at least one investment of interest and the at least one alternative investment; and preparing and sending investment fee reports comparing the at least one investment of interest with the at least one alternative investment.

Other and further features and advantages of the present invention will be apparent from the following descriptions of the various embodiments when read in conjunction with the accompanying drawings. It will be understood by one of ordinary skill in the art that the following embodiments are provided for illustrative and exemplary purposes only, and that numerous combinations of the elements of the various embodiments of the present invention are possible.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of embodiments of the present invention, reference is made to the following Detailed Description, which is to be read in association with the accompanying drawings, wherein:

FIG. 1 shows a networked environment illustrating one embodiment of one environment for practicing embodiments of the present invention;

FIG. 2 shows one embodiment of a device that may be included in a system implementing embodiments of the invention;

FIG. 3 shows one embodiment of a network device that may be included in a system implementing embodiments of the invention;

FIG. 4 illustrates a logical flow diagram generally showing one embodiment of a process for analyzing the cost of investment ownership over a network; and

FIG. 5 shows an exemplary look up table for mapping a mutual fund to a comparable ETF.

### DETAILED DESCRIPTION OF PREFERRED EMBODIMENTS

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. In a preferred embodiment a network is provided for the exchange of data and information. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements.

Briefly, embodiments of the present invention are directed to systems, methods, apparatuses, and computer readable mediums for providing an online investment advisory and management tool that analyzes the actual cost of ownership, over time, of mutual funds, determining ETFs that are comparable to the mutual funds and comparing the mutual fund costs with those costs associated with the identified comparable ETFs. The method includes an analysis of investment costs and the implicit asset allocation of the funds entered. The method provides an analysis of the costs and performance of the mutual funds and the identified comparable ETFs, based on objective criteria, and estimates the total cost of ownership over time. Although the exemplar embodiments are described with respect to ETFs, such description is not intended to be a limitation and the embodiments described and contemplated herein are equally applicable to any number of alternative investments, of which ETFs are merely one.

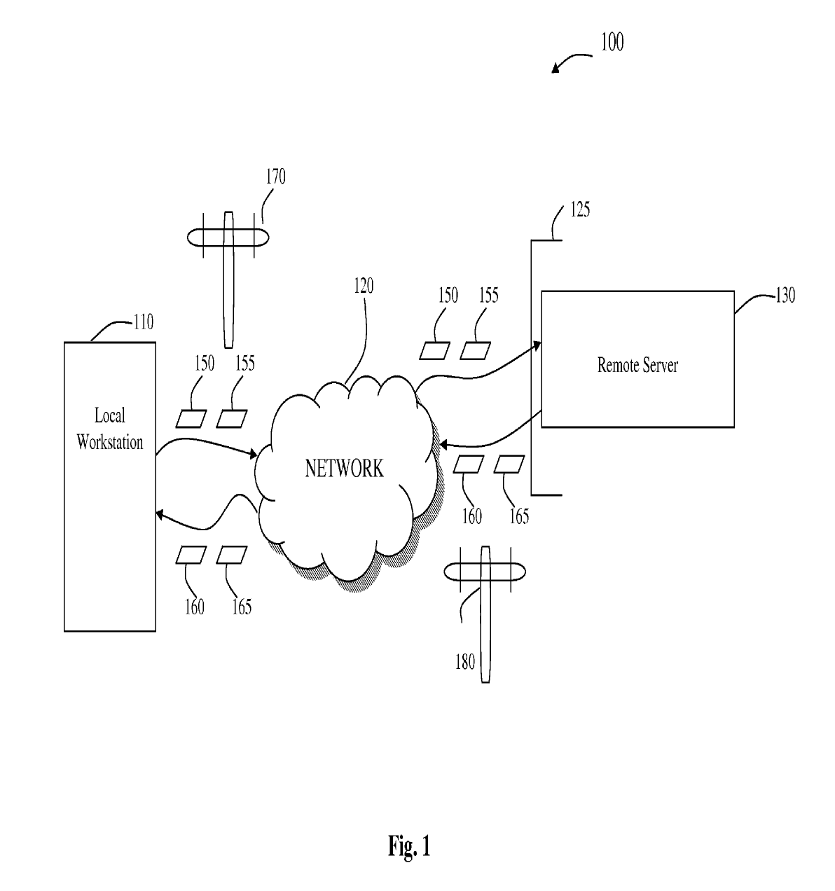

Turning now to the drawings, FIG. 1 is a block diagram of a system 100 for analyzing the actual cost of ownership of mutual funds and comparable ETFs via a network 120 from a local workstation 110, enabling access and delivery of information related to an user's particular mutual funds and providing the cost of owning the identified mutual funds and comparable ETFs between the local workstation 110 and a server 130. FIG. 1 shows components of one embodiment of an environment in which the invention may be practiced. Not all the components may be required to practice the invention, and variations in the arrangement and type of the components may be made without departing from the spirit or scope of the invention. The network may be any network such as a Local Area Network (LAN), Wide Area Network (WAN), an Extranet or an Internet. However, in a preferred embodiment the network 120 is the Internet. Although only one remote server 130 and local workstation 110 is depicted, one skilled in the art will recognize that any number of remote servers and local workstations may be utilized.

The network 120 is coupled to the local workstation 110 through a communication link 170, such as a wireless connection, phone line, modem, ISDN, cable line, digital subscriber line, infra-red link or the like. The network 120 is also coupled to the remote server 130 through a communication link 180, such as a wireless connection, phone line, cable line, digital subscriber line, infra-red link or the like. The local workstation 110 includes any device that can be coupled to the network 120 via the communication line 170. The local workstation 110 may be a personal computer, laptop computer, handheld computer, mainframe computer, PDA, smartphone, mobile device, netbook or any other device capable of computing, data processing or the like. Alternatively, the local workstation 110 may be thin client with all of the processing done remotely. Although not shown, remote data storage could also be connected to the local workstation 110. The communication link 170 between the workstation 110 and the network 120 allows workstation data 150 and queries 155 to be transmitted from the workstation 110 to the network 120, the communication link 180 between the network 120 and the server 130 transmits workstation data 150 and queries 155 from the network 120 to the remote server 130. The remote server may be protected by a firewall 125. Similarly, the communication link 180 between the server 130 and the network 120 allows server data 160 and inquiry data 165 to be transmitted from the server 130 to the network 120, and the communication link 170 between the network 120 and the workstation 110 transmits the server data 160 and the inquiry data 165 from the network 120 to the workstation 110. Server data includes but is not limited to web addresses, IP addresses, html, free ASCI text, css, javascript, java byte code, compiled application code (C, objective C, C++, C#, etc.), AJAX, ssl session keys, image data of various formats (pic, jpeg, gif, tiff, etc.), audio data of various formats (.wav, .aac, etc.) and video data of various formats (.mov, .mpg, .h264, etc.). Inquiry data includes but is not limited to listings of ETFs, search summaries, comparable investment reports, web address, ip address, html, free ASCI text, css, javascript, AJAX, ssl session keys, image data of various formats (pic, jpeg, gif, tiff, etc.), audio data of various formats (.wav, .aac, etc.) video data of various formats (.mov, .mpg, .h264, etc.) and user provided data such as first name last name, investment account information, banking data, personal data, email addresses, user name, password, etc. Embodiments of the present invention may be practiced as a single event or may be practiced as a series of events such that a user creates a user account with a user name and password. While illustrated as a single server 130, there could be multiple servers. Similarly, while a single workstation is depicted, one of skill in the art will understand that multiple workstations are contemplated within the scope of embodiments of the present invention.

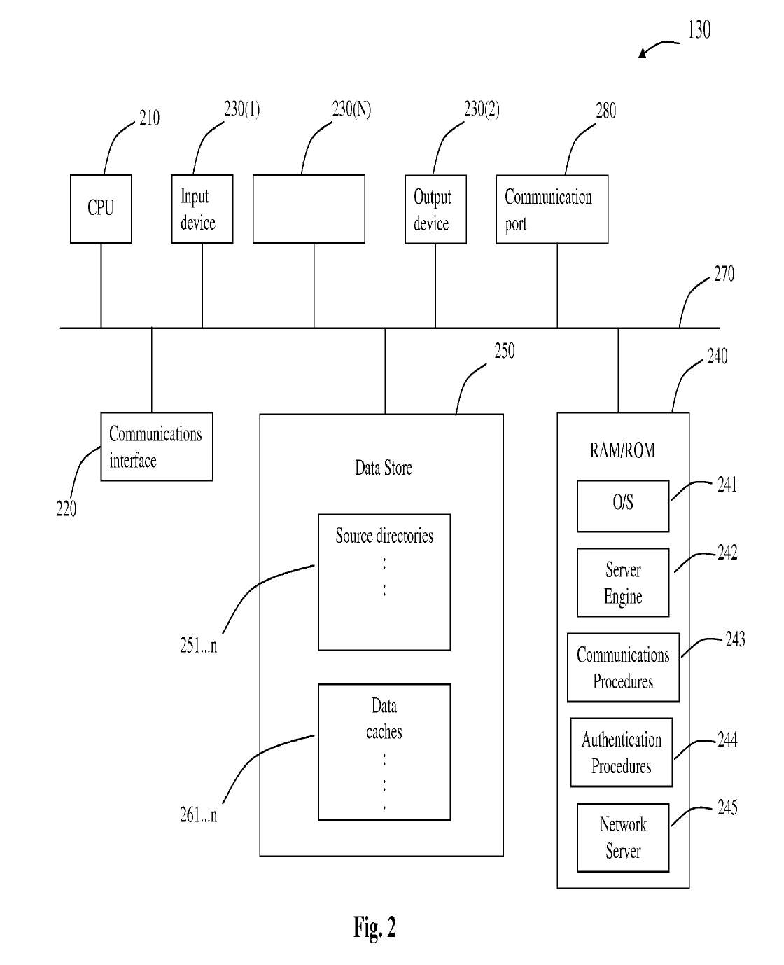

FIG. 2 is a block diagram of the remote server 130 shown in FIG. 1. The remote server 130 contains a plurality of components which may include central processing units (CPU) 210, communications interfaces 220, a host module, a communication ports 280, ports 230(1)-(N), where the ports may include input and output devices, such as a monitor and keyboard and “N” is any number; memory 240 of various kinds; data storage components 250 and circuits 270 that connects the aforementioned components. The communications interface 2320 and the communications port 280 preferably include one or more Network Interface Cards (NICs) configured to communicate with the network 120 and the local workstation 110. The memory 240 preferably comprises Random Access Memory (RAM) and/or Read Only Memory (ROM). The memory 240 preferably includes an operating system 241 which has instructions for communicating, processing, accessing, storing, or searching data. Non-limiting examples of suitable operating systems include MICROSOFT WINDOWS™, DOS™, UNIX™, LINUX™ and MAC OS™ which have instructions for communicating, processing, accessing, storing, and searching data. In addition, memory 240 preferably includes a server engine 242, communication procedures 243, authentication procedures 244, and a network server 245. The data store 250 includes source directories 251 . . . N containing software modules including a logic processing module, a fee module, a reporting module, a database module, a configuration file processing module, a data organization module, and a data display organization module. The database module is construed in its broadest terms to include a database module on a server either the hosts or a third party, a database available through a third party, or any data that the host can access. The software provides for at least the following: signing up new members, enabling members to log in, entering investment account data, entering secure account information and password data, matching mutual funds to comparable ETFs, establishing an account, collecting funds, and sending and receiving web-based communication (email instant message, chat, SMS, MMS, etc.), cache 261 . . . N for handling data such as user and/or prospective user information.

The communications procedures 243 are used for communicating with both the local workstation 110 and the network 120. The authentication procedures 244 are used for authenticating users. Successful completion of the authentication procedures gives users access to the data on the server.

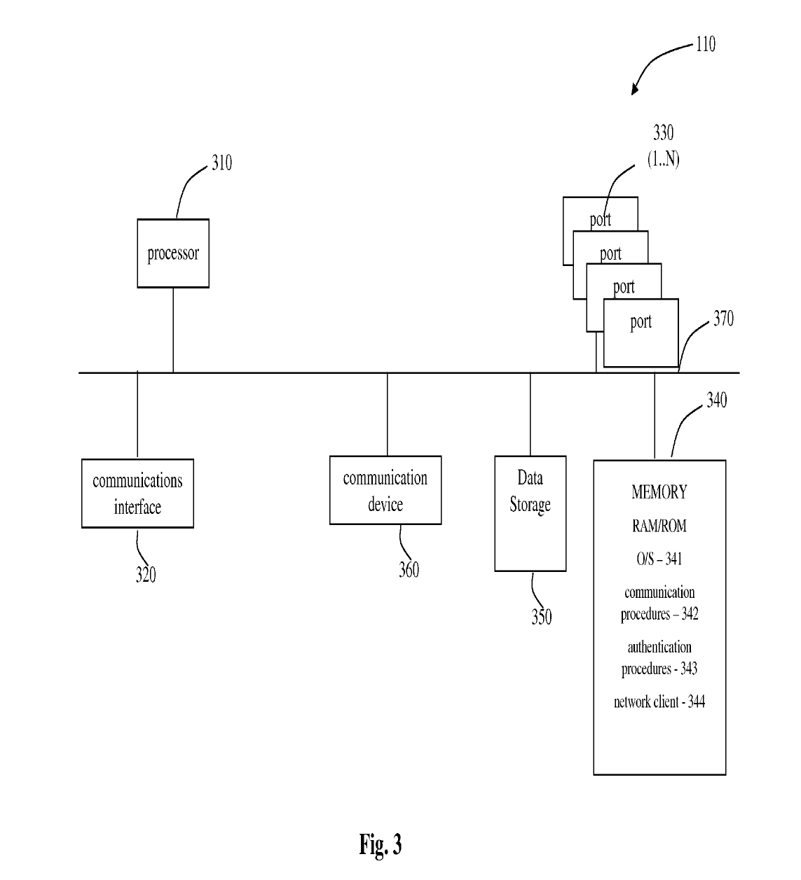

FIG. 3 is a block diagram of an exemplary local workstation 110 such as that shown in FIG. 1. The local workstation 110 comprises a plurality of components, such as a central processing unit (CPU) 310; communications interface 320; ports 330(1)-(N), where the ports include input and output devices, such as a monitor and keyboard and “N” is any number of devices; a memory 340; a data storage component 350, a communications device (i.e., modem) 360, and at least one bus 370 that connects the aforementioned components. The memory 340 preferably comprises Random Access Memory (RAM) and/or Read Only Memory (ROM). The memory also preferably includes an operating system 341, such as MICROSOFT WINDOWS™, DOS™ UNIX™, LINUX™, and MAC OS™, which has instructions for communicating, processing, accessing, storing, and searching data. The memory 340 further includes communications procedures 342, and authentication procedures 343, and a network client (web browser) 344.

The RAM preferably also has instructions for communicating, processing, accessing, and searching. Communications procedures are used for communicating with the network 120. Authentication procedures are used to authenticate the local workstation's 110 access to the remote server 130. Installation procedures are used to download and install necessary software and software modules onto the local workstation 110. In another embodiment, the user downloads all applications or installs such from media and the method is executed locally. In such an embodiment, updates may be provided and such updates may be obtained through the network or by supplying additional media. The configuration data contains the local workstation configuration information, such as the hardware and software that makes up the local workstation 110.

A network client 344 receives content or server data 160 from the remote server 130. The network client 344 is preferably a web based browser or similar type program, such as MICROSOFT'S INTERNET EXPLORER™, NETSCAPE'S NAVIGATOR™. MOZILLA FIREFOX™, GOOGLE CHROME™ or SAFARI™. The data storage 350 includes memory 351(1 . . . N) for storing data and reports, and data caches 352(1 . . . N).

The remote server can also be implemented as one or more “blades” where the term “blade” refers to one of multiple electronic circuit boards or cards that are installed in a hardware chassis with a backplane. An exemplary blade may include one or more processors, volatile and non-volatile memory, interfaces suitable for communicating information to and from the blade, and other components for enabling the operation of one or more applications. A blade may also include a specialized interface for the backplane and other interfaces, such as a USB port, FIREWIRE port, serial port, RF interface, IR interface, Ethernet interface, IDE controller, and the like. An application running on a blade may employ any of these interfaces to communicate information to other applications running on other blades and/or devices coupled to the blade server. The remote server can also be implemented as a combination of blades and additional components in the chassis.

Furthermore, embodiments of the present invention may be practiced on a cloud computing system such that the server is on the cloud.

In an embodiment of the present invention, a novel investment cost method is disclosed. An exemplary investment cost method provides for an electronic system to analyze the cost of an investment over time, and the cost of a comparable investment over time. Although the various embodiments are described with respect to mutual funds and ETFs, it is contemplated with the scope of the embodiments of the invention that the methods described are equally applicable to alternative investment vehicles and such are contemplated within the scope of the embodiments of the present invention.

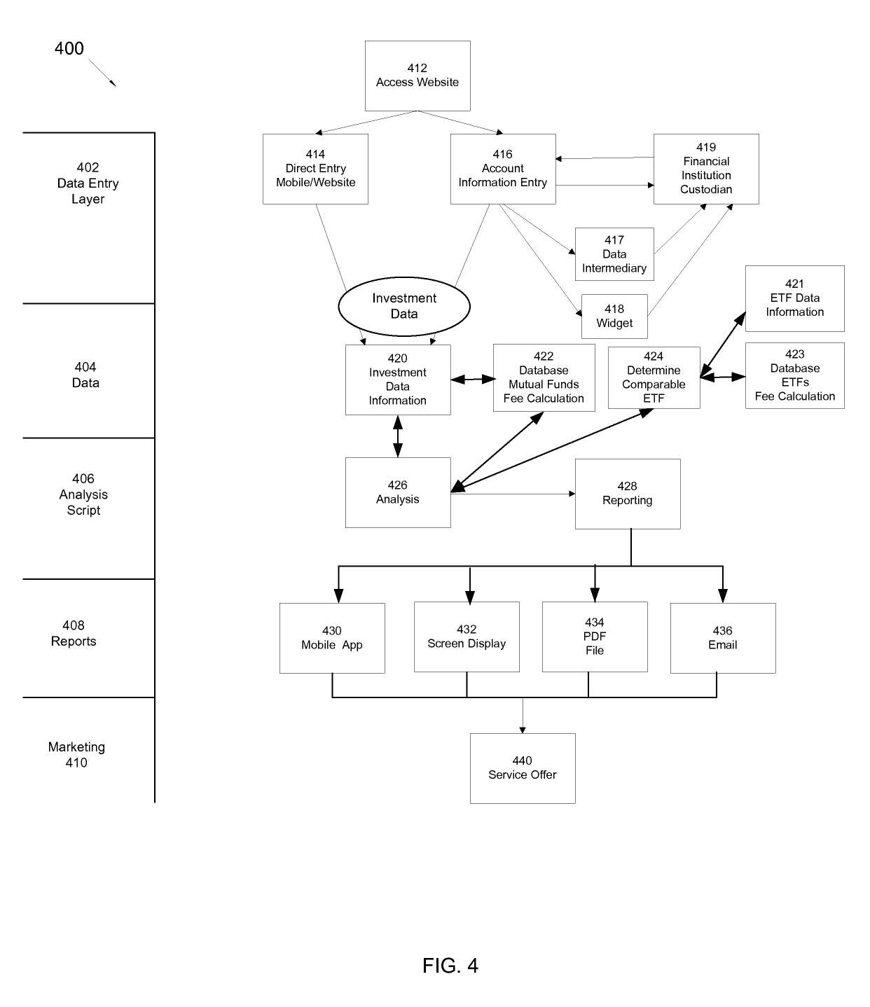

Turning now to FIG. 4. FIG. 4 illustrates an embodiment of a method 400 for calculating and comparing the cost of ownership of an identified investment with a comparable investment. The method is generally broken down into five stages: 1) a data entry layer 402, wherein a user enters personal data including investment data; 2) a data layer 404 wherein the user's investment data is compiled along with other investment data, i.e., comparable investments to the user's investments, included in a proprietary database; 3) an analysis layer 406 wherein fees and costs for the user specified investments and comparable investments are calculated; 4) a reporting layer 408 wherein reports are generated for the user; and 5) a marketing layer 410 wherein alternative investments may be presented.

A user begins by accessing a website or other host 412 in order to provide data to the host. In order to perform the necessary analysis, the user, must provide investment information to the host 412. The user inputs information regarding his current mutual fund holdings or mutual funds that he is considering for purchase. Although described as mutual founds, embodiments of the invention are not so limited and various and other investment types are contemplated within the scope of the embodiments. The information required includes, fund(s)/investment(s), and amount in each. The user could also input hypothetical fund(s)/investment(s) and amount(s). The investment data input may be provided in a variety of ways including, but not limited to, the following.

The data may be input manually 414. If the data is input manually, the user enters the information on a query form provided by the host when the user accesses a website or other interface. For example, the data may be input using a graphical user interface or other template. The user may enter his portfolio's mutual funds by either name or symbols and amounts invested, or alternatively mutual funds he is considering for purchase.

The data may also be input directly by accessing investment account data 416. In this embodiment, the host 412 accesses account information from brokerages and other financial institutions either through third party data providers 417, or third party investor account custodian such a Yodlee™ or through direct connections with the financial institutions, such as Fidelity, or Bank of America which may also act as a third party investor account custodian 419. Using this data entry mode, the user inputs the required information on the website or other interface, including but not limited to his investment account's custodian, account number and password. Once this information is provided, either through a third party service, or through its own “connectors” the host accesses the user's mutual fund holdings and amounts and compiles the information for use.

The investment data may also be obtained by implementing a widget 418 or a financial application, or through any other means that enables access to investment data. The host may provide a widget to financial institutions, either directly or through an intermediary offering such as that offered through an App Store that then provides it to their users on their website or portal. Users who are on such portal, may use the widget by instructing it to automatically pull their mutual fund data from one or more investment accounts.

The embodiments of the present invention are not limited to the use of a single data collection means and the above described means may be utilized alone or in any combination. Further, although disclosed with respect to actual user investments, the embodiments of the invention may also perform the analysis on a hypothetical set of mutual funds.

After the investment data is collected, for each mutual fund symbol and amount invested, the host looks up the available investment data information 420 either located within a database coupled to the server or by accessing data or a database available on an outside or third party server or located on a database maintained by a partner.

The host then calculates the estimated fees 422. The estimated fees may include Net Operating Expenses, 12(b)1 marketing fees, front-end loads, and any other fees charged for the investment vehicle. These fees then compiled and a total expense of ownership is calculated. In addition, for relevant categories, the host also calculates excess taxes paid using the mutual fund's turnover percentage and adds this amount to determine the total actual cost.

Next, the host after analysis 426 determines an alternative investment, in this example, a comparable ETF 424, which for example may be a comparable ETF is a comparable compilation of stocks. The comparable ETF is determined. In its simplest embodiment, the comparable ETF may be determined utilizing a variety of standard categorization methods such as Morningstar's categories, or other methods that match the investment style of the mutual fund to a competing ETF. In a non-limiting example, if a “large cap growth” mutual fund, which is one of the 84 Morningstar categories is the investment vehicle then, a comparable ETF may be a “large cap growth” ETF. In addition, for evaluation purposes, the method may display multiple ETFs in a category to illustrate to the user a variety of alternative choices to the existing mutual fund. Once the comparable ETFs are determined, the host looks up the available investment data information 421 either located within a database coupled to the server or by accessing data or a database available on an outside or third party server.

The host then calculates the estimated fees 423. The estimated fees may include Net Operating Expenses, 12(b)1 marketing fees, front-end loads, and any other fees charged for the investment vehicle. These fees then compiled and a total expense of ownership is calculated. It is contemplated that an iterative process may be performed to identify comparable ETFs so that the lowest cost ETFs may be selected.

In another embodiment, comparable ETFs may be determined through a more detailed analysis. It is common for mutual funds to advertise as being one type of fund, however, a further analysis of the mutual funds' holdings may reveal that it does not belong in the advertised category. For example, if a Foreign Large Cap Blend mutual fund has 15% of its holdings in U.S. equities, the classification would reflect the true nature of the fund's holdings. The financial services industry refers to this as “Style Drift” wherein the active manager's true investment style drifts from the one that has been advertised.

In one embodiment of the invention an algorithm is executed that matches each mutual fund to one or more broad-based indexes. After matching the mutual fund to the index, it then relates the mutual fund to one or more ETFs to create a true conversion. In such method, the algorithm first analyzes the most recently reported holdings in the mutual fund and categorizes all holdings utilizing a variety of criteria. For example, for equities, the categorization involves asset class, sector, industry, country, market capitalization and a variety of operating metrics. For bonds, the categorization is based upon type of bond, duration, issuer, risk and a variety of other metrics. Similarly, other asset classes such as, but not limited to, currencies or commodities, are categorized using factors appropriate to those classes and specialized funds such as Target Date funds are categorized appropriately.

After the fund holdings are analyzed, the method matches these holdings with common broad-based industry indices that are commonly used by the investment industry and published by Standard and Poors, MSCI and others. In some matchings, the fund matches one index, but more often, the fund actually is comprised of a composite of indexes because of Style Drift. If the fund is comprised of a composite of indexes, the method performs a matching function by using identified tolerance levels. For example, if a mutual fund consists of 100 securities, and 97 of them are in the S&P 500, then this fund will be categorized as a 100% S&P 500 mutual fund. However if the fund had 50 small cap and 50 S&P 500 securities, then it would be categorized as 50% in the S&P 500 and 50% in the S&P Small Cap 600. In an embodiment where holdings are matched with common broad-based industry indices, first all of the holdings are identified, classified and then tested against the index they most resemble and then are grouped as a percentage of the mutual fund into that index category. This method is repeated until the entire mutual fund is parsed into one or more indexes.

Next, the method applies the same identifying/matching process to build a table or database (hereinafter “table”) of ETFs that most accurately imitates or are otherwise comparable to these investment industry indices. The process for building this table of ETFs includes using past performance of the ETF against its index. Once the mutual fund has been parsed into one or more indices, the method determines the comparable ETFs in proportion to the mutual fund's holdings to convert the mutual fund into one or more ETFs in order to factor in the effects of Style Drift on the analysis.

The method separates categories of all mutual funds by investment category and calculates the user's exposure to each category, also known as asset class. This exposure calculation shows the user the implicit asset allocation in the portfolio and can be used later for marketing purposes. For example if a user has all emerging market mutual funds, then the user may be advised via the communications, discussed below, that the allocations are very risky. This provides the user an opportunity to consider whether or not it is intended or desired to have a portfolio that skewed to such a high-risk category. The investment method disclosed herein is based upon how the user allocates to various categories, so knowing the current allocations enables the method to further demonstrate how the allocations may be adjusted.

The host then calculates the yearly difference in fees between a portfolio of one or more mutual funds and the identified comparable ETFs 426. Based upon the category, the host determines a rate of compounding, and then calculates the compounded rate of return between the two portfolios over various time horizons.

After the analysis is completed 426, the information is prepared for delivery to the user in the form of a report 428. The information may be delivered in a variety of ways including through a mobile application 430, through a screen display 432, by electronic delivery such as through email with an attached PDF or other file 434, through email its self in the body of a text 436, the information could also be made available, through facsimile transmission, mail, or any other delivery means whether electronic, soft or hard copy. In order for the user to obtain the analysis electronically, he inputs his email address on either the website or widget. The host stores all of the information collected above in a database, for example in a mySQL database with the user's email address. Using this information, the host formats the analysis of delivery as indicated previously, i.e., for display to the user on the website, a PDF file to be emailed to the user or downloaded, for display via HTML in an email that is sent to the user. The report displays all calculations and by category, the user's mutual fund investments, and then a list of fees that are totaled. In addition, they display the corresponding ETFs, and the analysis showing how the incremental mutual fund fees over the ETF fees can effect a portfolio's returns.

The collected data and the comparable data maybe used to format marketing materials and create an offer for the user 440. Further the marketing may include a composite analysis of the total cost of ownership over the lifetime of the investment, the cost of ownership at retirement, the expected life of available funds, or any other cost or life calculations that may be desired. For example, the user could request calculations based on a certain draw date, a certain annual draw amount, an expected length of time the user expects to need the funds for. The same calculations may also be made for an alternative or comparable investment and the differences in fees and costs may be presented to the user in addition to the raw data. Further, included within the scope of the various calculations is the ability to create graphics displaying the information.

Embodiments of the present invention also provide for marketing services to the user. These services include lower cost investment advisory services and replacement advisory services. These services may be offered directly or through distribution partners. For example, the analysis tool may be embedded into the websites of third parties wherein the third party presents the analysis and the user information or “lead” may be forwarded to the originating party.

Further embodiments of the invention provide for marketing tool through network based third parties and owners of money management, investment, financial data or recording keeping tools. For example, the method may enable the host to provide a communication link to its services on a third party's website or other host. The communication link may be static such that it is merely available for a user's use, i.e., the use may initiate the contact, or it may be dynamic such that it encourages a user to explore the host's services. In the latter instance, the communication link may demonstrate a financial incentive or benefit that would result from use of the investment tool.

If the communication link is dynamic and the third party has access to a users financial data, the investment tool and analysis may be pushed without user intervention to demonstrate the benefits of the embodiments of the investment tool.

Further, embodiment of the present invention include a lead generation tool, wherein the host partners with third parties who provide financial advise and guidance to its users for whom it already has financial or investment data. Such partners may obtain the data from the host service and present it directly on their network, or alternatively direct the user to the host's network.

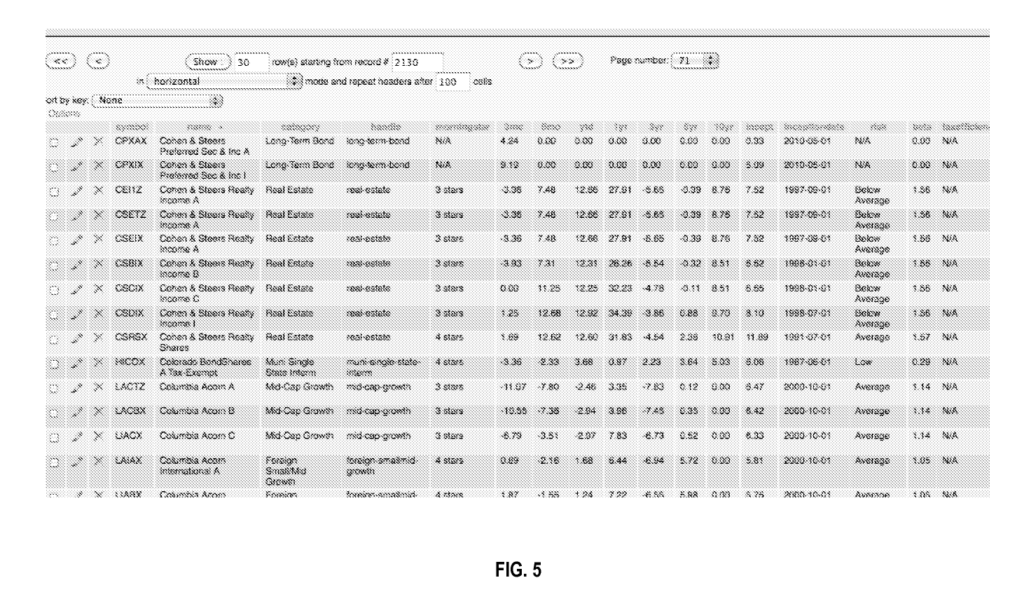

FIG. 5 shows an example screen of a database for identifying a comparable ETF. As shown, various criteria are used including the category type, Morningstar rating, risk category, fees, management name. In one embodiment the contains a look-up table where the mutual funds are displayed and pre-matched to one of more ETFs. The table includes a listing of all the expenses necessary to perform the required calculations. The database may be dynamic in that the comparable ETF funds may vary as the fund costs, rates, etc. change over time. Further, in another embodiment, the information is contained in the database and a query is run to find the comparable ETF. The query may include an iterative process wherein the user is given an opportunity to specify variable that are desirable to the user, i.e., risk, return, costs to identify an ETF.

As noted previously the forgoing descriptions of the specific embodiments are presented for purposes of illustration and description. They are not intended to be exhaustive or to limit the invention to the precise forms disclosed and obviously many modifications and variations are possible in view of the above teachings, including equivalents. The embodiments were chosen and described in order to explain the principles of the invention and its practical applications, to thereby enable those skilled in the art to best utilize the invention and various embodiments thereof as suited to the particular use contemplated. It is intended that the scope of the invention be defined by the claims and their equivalents.

1. A system for generating an investment fee analysis report comprising:
a host module, said host module being adapted to receive investment information about at least one investment of interest to an investor and including a data input link for receiving information about said at least one investment of interest;
a first logic processing module programmed to determine at least one alternative investment that is comparable to said at least one investment of interest, wherein said logic processing module uses predefined criteria to identify said at least one alternative investment;
a database module, said database module being adapted to obtain data concerning said at least one alternative investment and said at least one investment of interest;
a fee module, said fee module being adapted to determine ownership fees associated with said at least one investment of interest and said at least one alternative investment;
a reporting module, said reporting module being adapted to prepare and send investment fee reports to said investor concerning said at least one investment of interest and said at least one alternative investment.

2. The system of claim 1, wherein the information about at least one investment of interest to an investor is received by said host module from a client computer.

3. The system of claim 1, wherein the information about at least one investment of interest to an investor is received by said host module in communication with a secure third party investor account custodian via the Internet or other network.

4. The system of claim 3, wherein said host module is configured to provide investor security information to permit receipt of the information about at least one investment of interest to an investor.

5. The system of claim 1, wherein said at least one alternative investment is an ETF.

6. The system of claim 1, wherein said predefined criteria is at least one Morningstar code.

7. The system of claim 3, wherein the information about at least one investment of interest to an investor is received by said host module from an intermediate third party data aggregator in communication with the secure third party investor account custodian via the Internet or other network.

8. The system of claim 1, wherein said first logic processing module:
matches said at least one investment of interest to at least one broad based index; and
relates said at least one investment of interest to at least one alternative investment from a comparable broad based index.

9. The system of claim 1, wherein said first logic processing module:
analyzes reported holding in said at least one investment of interest;
categorizes said reported holdings;
matches said categorized reported holding with industry indices; and
relates said matched categorized reported holding to at least one alternative investment.

10. The system of claim 9, wherein said first logic processing module matches said categorized reported holding in said at least one investment of interest with at least one indices and relates said matched categorized holding to said at least one alternative investment in proportion to said at least one indices.

11. The system of claim 1, further comprising a communication link to said system from a third party host.

12. The system of claim 11, wherein said system sends said investment fee reports to said third party host, and wherein said third party host displays said investment fee reports to said investor.

13. A computer readable medium encoded with a computer program for generating an investment fee analysis report, the computer program comprising instructions for:
identifying at least one investment of interest;
receiving information about said at least one investment of interest;
determining at least one alternative investment that is comparable to said at least one investment of interest;
receiving information about said at least one alternative investment;
determining ownership fees associated with said at least one investment of interest and said at least one alternative investment; and
preparing and sending investment fee reports comparing said at least one investment of interest and said at least one alternative investment.

14. The computer readable medium encoded with a computer program of claim 13, wherein indentifying said at least one investment of interest comprises receiving data from a user.

15. The computer readable medium encoded with a computer program of claim 13, wherein identifying said at last one investment of interest comprises receiving data from a third party.

16. The computer readable medium encoded with a computer program of claim 13, wherein determining said at least one alternative investment comprises utilizing a standard categorization method.

17. The computer readable medium encoded with a computer program of claim 13, wherein determining said at least one alternative investment comprises:
matching said at least one investment of interest to at least one broad based index; and
relating said at least one investment of interest to at least one alternative investment from a comparable broad based index.

18. The computer readable medium encoded with a computer program of claim 13, wherein determining said at least one alternative investment comprises:
analyzing reported holding in said at least one investment of interest;
categorizing said reported holdings;
matching said categorized reported holding with industry indices; and
relating said matched categorized reported holding to at least one alternative investment.

19. The computer readable medium encoded with a computer program of claim 18, wherein said matched categorized reported holding in said at least one investment of interest comprises at least one indices and relating said matched categorized holding to said at least one alternative investment is performed in proportion to said at least one indices.
